(19) United States
(12) Patent Application Publication
(10) Pub. No.: US 2021/0367780 A1
(43) Pub. Date: Nov. 25, 2021

(54) ADAPTER APPARATUS AND PROCESSING METHOD

(71) Applicant: SONY CORPORATION, TOKYO (JP)

(72) Inventors: MUNETAKE EBIHARA, TOKYO (JP); HIROSHI KUNO, KANAGAWA (JP); KOJI YOSHIMURA, KANAGAWA (JP)

(21) Appl. No.: 16/325,720

(22) PCT Filed: Sep. 1, 2017
(86) PCT No.: PCT/JP2017/031589

§ 371 Date: Feb. 14, 2019

(30) Foreign Application Priority Data
Sep. 15, 2016 (JP) 2016-180209

(51) Int. Cl. H04L 9/08; H04W 4/80

(52) U.S. Cl. CPC H04L 9/0897; H04W 4/80; H04L 9/0866; H04L 9/0869

(57) ABSTRACT

The present technology relates to an adapter apparatus configured to enabling a recording medium to be more safely and easily carried, and a processing method. An encryption processing part in an adapter apparatus encrypts data written in a storage apparatus, and a decryption processing part decrypts the data read from the storage apparatus. A key storage part stores the same common key as a key used to encrypt and decrypt the data and stored in another adapter apparatus. The present technology is applicable to encryption adapters configured to connect a USB memory to PCs placed at a worksite and home, respectively, for example.

### TECHNICAL FIELD

The present technology relates to an adapter apparatus and a processing method, and particularly to an adapter apparatus configured to enable a recording medium to be easily carried, and a processing method.

### BACKGROUND ART

In recent years, there has been known, as an encrypted storage easily usable without the need to construct an information management system or the like, a USB memory configured to decrypt in a case where an input password is correct, and to enable data to be read and written.

In order to encrypt and decrypt data, dedicated encryption software needs to be installed in a PC and a keyboard is required to input a password. Further, dedicated encryption software needs to be installed in a Smartphone for a USB memory capable of reading and writing data from and into a portable terminal such as Smartphone. Software for general-purpose terminals such as PC and Smartphone is relatively easily developed, but software for dedicated terminals such as Blu-ray (trademark) Disc recorder or medical recorder is not easily developed.

Further, it is not easy to achieve both security intensity and convenience of password. For example, in a case where user's birthday or the like is used as a password, its storage is easy and more convenient, but is easily estimated and low in security intensity. To the contrary, in a case where such password setting is prohibited, its storage is difficult and less convenient.

Further, for example, in a case where the use of a password is changed from protection of personal data to protection of worksite data, the password for protection of personal data is not appropriate for being shared at worksites in many cases.

Patent Document 1 discloses that an encryption adapter present between a PC and a storage includes a function of encrypting a storage such as USB memory.

### CITATION LIST

### Patent Document

### Patent Document 1: Japanese Patent Application Laid-Open No. 2011-107801

### SUMMARY OF THE INVENTION

### Problems to be Solved by the Invention

However, a password is required also in the configuration of Patent Document 1, and thus a user is faced with both security intensity and convenience thereof.

The present technology has been made in terms of such a situation, and is directed to enable a recording medium to be more safely and easily carried.

An adapter apparatus of the present technology includes: an encryption processing part configured to encrypt data written in a storage apparatus; a decryption processing part configured to decrypt the data read from the storage apparatus; and a key storage part configured to store the same common key as a key used to encrypt and decrypt the data and stored in another adapter apparatus.

### Solutions to Problems

A key generation part configured to generate the common key is further provided, and the key storage part can further store the common key generated by the key generation part.

A communication part configured to make communication with a communication device is further provided, and the key generation part can generate the common key by use of device IDs of a plurality of communication devices acquired when the communication part makes communication with the plurality of communication devices.

A processing method of the present technology includes steps performed by an adapter apparatus of: generating a common key, and storing the generated common key; and the adapter apparatus including: an encryption processing part configured to encrypt data written in a storage apparatus; a decryption processing part configured to decrypt the data read from the storage apparatus; and a key storage part configured to store the same common key as a key used to encrypt and decrypt the data and stored in another adapter apparatus.

According to the present technology, data written in a storage apparatus is encrypted, the data read from the storage apparatus is decrypted, and the same common key as a key used to encrypt and decrypt the data and stored in another adapter apparatus is stored.

### Effects of the Invention

According to the present technology, it is possible to enable a recording medium to be more safely and easily carried.

### BRIEF DESCRIPTION OF DRAWINGS

FIG. 1 is a diagram illustrating an exemplary configuration of an information management system according to the present technology.

FIG. 2 is a block diagram illustrating an exemplary configuration of an encryption adapter.

FIG. 3 is a flowchart for explaining a data transfer processing.

FIG. 4 is a diagram illustrating a first example of sharing an encryption key.

FIG. 5 is a flowchart for explaining a flow of sharing an encryption key.

FIG. 6 is a diagram illustrating a second example of sharing an encryption key.

FIG. 7 is a flowchart for explaining a flow of sharing an encryption key.

FIG. 8 is a diagram illustrating a third example of sharing an encryption key.

FIG. 9 is a flowchart for explaining a flow of sharing an encryption key.

FIG. 10 is a diagram illustrating another third example of sharing an encryption key.

FIG. 11 is a block diagram illustrating other exemplary configuration of the encryption adapter.

FIG. 12 is a diagram illustrating a fourth example of sharing an encryption key.

FIG. 13 is a flowchart for explaining a flow of sharing an encryption key.

FIG. 14 is a diagram illustrating an example in which data is not read and written in other than a specific adapter.

FIG. 15 is a diagram illustrating an example in which data is not read and written in other than a specific adapter.

### MODE FOR CARRYING OUT THE INVENTION

Preferred embodiments of the present technology will be described below in detail with reference to the drawings. Additionally, the components having substantially the same functional configurations are denoted with the same reference numerals in the present specification and the drawings, and the repeated description thereof will be omitted.

Further, the description will be made in the following order.

1. Outline of system

2. Configuration and data transfer processing of encryption adapters

3. First example of sharing encryption key

4. Second example of sharing encryption key

5. Third example of sharing encryption key

6. Fourth example of sharing encryption key

7. Example in which data is not read and written in other than specific adapter

### <1. Outline of System>

An outline of an information management system according to the present technology will be first described.

### (Exemplary Configuration of Information Management System)

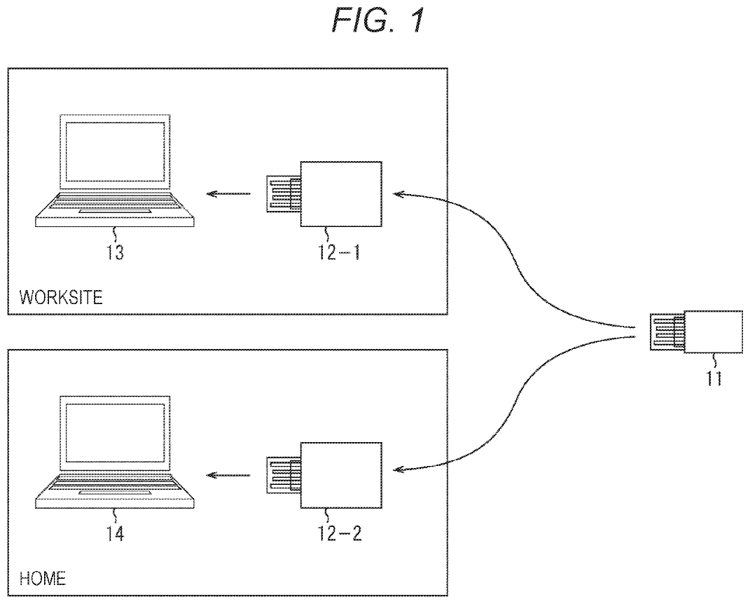

FIG. 1 illustrates an exemplary configuration of an information management system according to the present technology.

The information management system of FIG. 1 is configured of a removable storage 11, encryption adapters 12-1, 12-2, and host devices 13, 14.

The removable storage 11 is particularly configured of a portable storage apparatus such as universal serial bus (USB) memory, SD memory card, external hard disc drive (HDD), and the like, and stores file systems or file data. The removable storage 11 has an interface for USB, SD standard, or the like configured to supply power or to make data communication. The interface of the removable storage 11 may be for near field communication such as TransferJet (trademark).

The encryption adapter 12-1 is connected between the removable storage 11 and the host device 13, encrypts data written from the host device 13 into the removable storage 11, and decrypts the data read from the removable storage 11 into the host device 13.

The encryption adapter 12-2 is connected between the removable storage 11 and the host device 14, encrypts data written from the host device 14 into the removable storage 11, and decrypts the data read from the removable storage 11 into the host device 14.

The encryption adapters 12-1 and 12-2 are in the form of USB hub, memory card reader/writer, or the like, and have an interface for USB, SD standard, or the like as an interface with the removable storage 11. Further, the encryption adapters 12-1 and 12-2 have interfaces for USB, PCI Express, Wi-Fi, or the like as interfaces with the host devices 13 and 14, respectively.

The host devices 13 and 14 are configured of a portable terminal such as personal computer (PC) or Smartphone, a Blu-ray (trademark) Disc recorder, a medical recorder, or the like. In the example of FIG. 1, the host device 13 and the encryption adapter 12-1 are placed at a user's worksite, and the host device 14 and the encryption adapter 12-2 are placed at the user's home.

The encryption adapters 12-1 and 12-2 previously have an encryption key used for encryption and decryption. Specifically, a pair of encryption adapters 12-1 and 12-2 is shipped after manufactured, and is set with the same encryption key (denoted as common key below) before shipment.

Only one common key is shared in persons or per group accessible to the data stored in the removable storage 11.

With the configuration, the user can carry the removable storage 11 and can browse and edit the data stored in the removable storage 11 both at his/her worksite and at his/her home. Further, the data stored in the removable storage 11 cannot be accessed without the encryption adapters 12-1 and 12-2. Thus, even if the user loses the removable storage 11 outside his/her worksite or home, a third party who obtains it cannot browse and edit the data stored in the removable storage 11.

Additionally, the above example assumes that two encryption adapters are paired and shipped and are set with a common key, but a set of three or more encryption adapters may be shipped and set with a common key.

### <2. Configuration and Data Transfer Processing of Encryption Adapters>

A configuration of the encryption adapters 12-1 and 12-2 and a data transfer processing performed by the encryption adapters will be described below. Additionally, the encryption adapters 12-1 and 12-2 are not discriminated and will be simply denoted as encryption adapter 12 below.

### (Exemplary Configuration of Encryption Adapter)

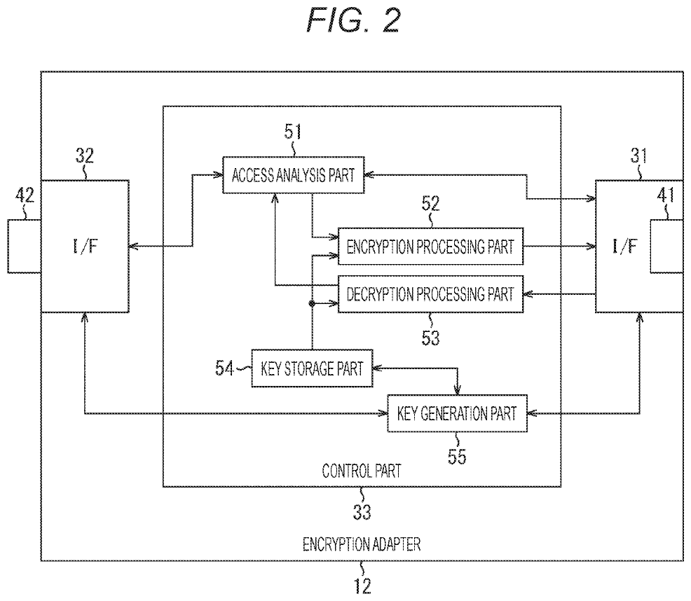

FIG. 2 is a block diagram illustrating an exemplary configuration of the encryption adapter 12.

As illustrated in FIG. 2, the encryption adapter 12 is configured of interfaces (I/F) 31, 32, and a control part 33.

The I/F 31 is an interface configured to make communication with the removable storage 11, and is for USB or SD standard, TransferJet, or the like, for example. The example of FIG. 2 assumes that the I/F 31 is an interface for USB. The I/F 31 has a USB socket 41 into which a USB plug of the removable storage 11 is inserted.

The I/F 32 is an interface configured to make communication with the host device 13 or the host device 14, and is for USB, PCI Express, Wi-Fi, or the like, for example. The example of FIG. 2 assumes that the I/F 32 is an interface for USB. The I/F 32 has a USB plug 42 inserted into a USB socket of the host device 13 or the host device 14.

The control part 33 controls the accesses from the host device 13 or the host device 14 to the data in the removable storage 11.

The control part 33 is configured of an access analysis part 51, an encryption processing part 52, a decryption processing part 53, a key storage part 54, and a key generation part 55.

The access analysis part 51 analyzes an access instruction from the I/F 32 to the I/F 31, and performs a processing depending on the analysis result. For example, in a case where the access instruction to the removable storage 11 is to write or read data, a processing of accessing via the encryption processing part 52 or the decryption processing part 53 is performed. Further, in a case where the access instruction to the removable storage 11 is not to write or read data, a processing of accessing via the access analysis part 51 is performed.

The encryption processing part 52 encrypts data to be written in the removable storage 11 by use of an encryption key. The decryption processing part 53 decrypts the data read from the removable storage 11 by use of the encryption key.

The encryption processing part 52 and the decryption processing part 53 may be realized in hardware or in software. In a case where the encryption processing part 52 and the decryption processing part 53 are realized in hardware, they are configured of intellectual property (IP) for advanced encryption standard (AES) using a 256-bit key, for example.

The key storage part 54 stores the encryption key used for encryption by the encryption processing part 52 and decryption by the decryption processing part 53. The key storage part 54 is assumed as a region which is difficult to access from the outside. The encryption key is secret key data capable of being set per encryption adapter 12. The encryption key is a 256-bit key used for AES, for example, and is assumed at a value generated by AES-encrypting the key ID of the encryption adapter 12 at 256 bits, or the like.

Further, as described with reference to FIG. 1, the encryption key stored in the key storage part 54 is a common key shared with the other encryption adapter 12.

The key generation part 55 generates a new encryption key (common key) when one encryption adapter 12 is connected to the other encryption adapter 12, for example. The key storage part 54 further stores the common key generated by the key generation part 55.

### (Data Transfer Processing)

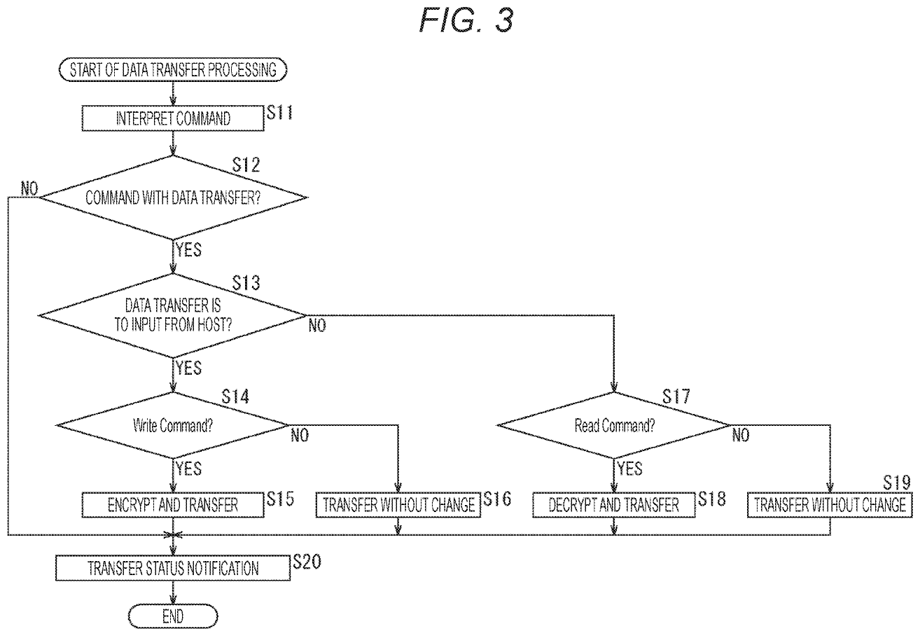

The data transfer processing performed by the encryption adapter 12 will be described below with reference to the flowchart of FIG. 3. It is assumed herein that the data transfer processing is performed in USB Mass Storage Class. The processings of FIG. 3 start when an access from the host device 13 or the host device 14 to the removable storage 11 is detected.

In step S11, the access analysis part 51 analyzes an access instruction from the I/F 32 to the I/F 31 thereby to interpret the command.

In step S12, the access analysis part 51 determines whether or not the interpreted command is a command with data transfer.

In step S12, in a case where it is determined that the command is with data transfer, the processing proceeds to step S13. In step S13, the access analysis part 51 determines whether or not the data transfer is an input from the host device 13 or the host device 14 (an output to the removable storage 11).

In step S13, in a case where it is determined that the data transfer is an input from the host device 13 or the host device 14, the processing proceeds to step S14. In step S14, the access analysis part 51 determines whether or not the command is a Write Command.

In step S14, in a case where the command is determined as a Write Command, the processing proceeds to step S15. In step S15, the encryption processing part 52 encrypts data to be transferred to be, for example, AES_Encrypt(Key_data, data) or the like by use of the encryption key Key_data stored in the key storage part 54, and transfers it (outputs it to the removable storage 11).

On the other hand, in step S14, in a case where it is determined that the command is not a Write Command, the processing proceeds to step S16. In step S16, the access analysis part 51 transfers data to be transferred as it is (outputs data to be transferred to the removable storage 11).

Further, in step S13, in a case where it is determined that the data transfer is not an input from the host device 13 or the host device 14, the processing proceeds to step S17. In step S17, the access analysis part 51 determines whether or not the command is a Read Command.

In step S17, in a case where the command is determined as a Read Command, the processing proceeds to step S18. In step S18, the decryption processing part 53 decrypts data to be transferred to be, for example, AES_Decrypt (Key_data, data) or the like by use of the encryption key Key_data stored in the key storage part 54, and transfers it (outputs it to the host device 13 or the host device 14).

On the other hand, in step S17, in a case where it is determined that the command is not a Read Command, the processing proceeds to step S19. In step S19, the access analysis part 51 transfers data to be transferred as it is (outputs data to be transferred to the host device 13 or the host device 14).

Incidentally, in step S12, in a case where it is determined that the command is not with data transfer, or after step S15, S16, S18, or S19, the processing proceeds to step S20.

In step S20, the access analysis part 51 transfers a status notification, and terminates the processing.

In this way, in a case where the command is a Write Command or a Read Command, data is transferred via the encryption processing part 52 or the decryption processing part 53, and in a case where the command is other command such as Inquiry or the like, data is transferred not via the encryption processing part 52 or the decryption processing part 53. Additionally, the Write Command or the Read Command includes a write destination or read source address, and thus only a specific address may not be encrypted.

The data encrypted and written in the removable storage 11 in this way cannot be decrypted without the encryption key Key_data, but the encryption key Key_data stored in the encryption adapter 12 is high in encryption intensity, and cannot be assumed by a third party. Thus, even if the user loses the removable storage 11 outside his/her worksite or home, a third party who obtains it cannot browse and edit the data stored in the removable storage 11.

Further, dedicated encryption software does not need to be installed in a PC and a password does not need to be input by use of a keyboard or the like unlike the configuration in which reading and writing data is managed by a password, and data can be encrypted or decrypted only in a hardware configuration.

Further, data is encrypted by a sufficiently-long encryption key, and thus the user is not concerned about vulnerability of the password. Further, the user can manage the access to the data physically or intuitively by distribution, management of the places, recovery, and the like of the encryption adapters having the same encryption key.

As described above, the user can more safely and easily carry a recording medium saving confidential data therein.

The present technology can be applied to a form in which data stored in one removable storage is accessed by use of encryption adapters at two or more places, a form in which a plurality of users have encryption adapters, respectively, in a group at work, for example, and common data is saved in each user's removable storage, and the like.

Incidentally, for example, in a case where a larger number of users want to use common data in a group, or the like, it is better to increase the number of encryption adapters having the same encryption key. For example, it is better that a reset encryption key is shared among the encryption adapters.

Thus, there will be described below an example in which a reset encryption key is shared among encryption adapters.

### <3. First Example of Sharing Encryption Key>

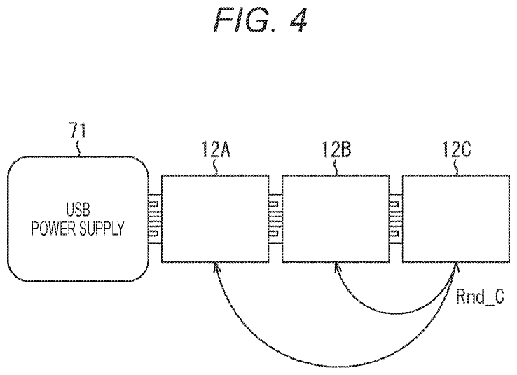

FIG. 4 is a diagram illustrating a first example of sharing an encryption key.

In the example of FIG. 4, three encryption adapters 12A, 12B, and 12C are serially connected. Further, the encryption adapter 12A is connected to a USB power supply 71. Thereby, not only the encryption adapter 12A but also the encryption adapters 12B and 12C are supplied with power.

A key distribution master key Key_m is embedded in a region which is difficult to access from the outside (the key storage part 54) in the encryption adapters 12A, 12B, and 12C before shipment.

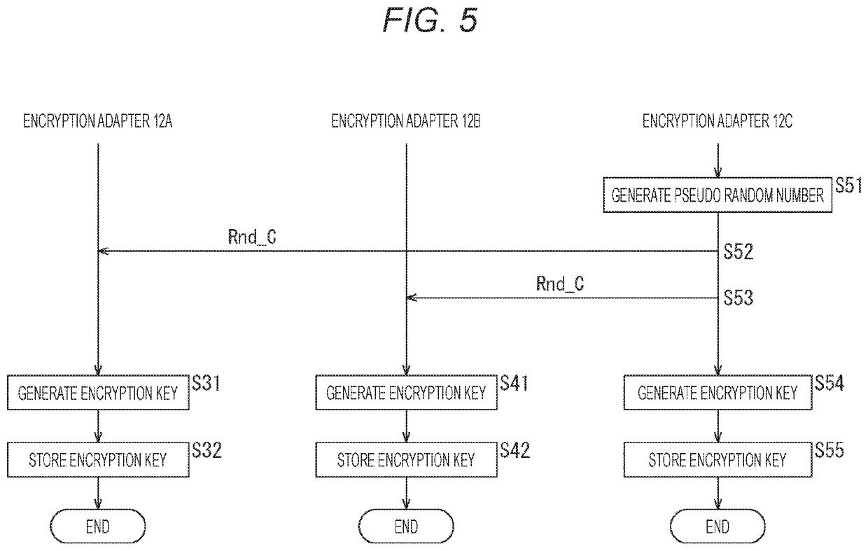

A flow of the processing of sharing a reset encryption key among encryption adapters will be described herein with reference to FIG. 5.

When the encryption adapters 12A, 12B, and 12C are mutually connected, in step S51, the encryption adapter 12C generates a pseudo random number Rnd_C.

In steps S52 and S53, the encryption adapter 12C transfers the generated pseudo random number Rnd_C to the encryption adapters 12A and 12B.

The key generation part 55 in the encryption adapter 12A generates an encryption key Key_data=AES_Encrypt(Key_m, Rnd_C) by use of the pseudo random number Rnd_C in step S31, and stores the encryption key in the key storage part 54 in step S32.

The key generation part 55 in the encryption adapter 12B generates an encryption key Key_data=AES_Encrypt(Key_m, Rnd_C) by use of the pseudo random number Rnd_C in step S41, and stores the encryption key in the key storage part 54 in step S42.

The key generation part 55 in the encryption adapter 12C generates an encryption key Key_data=AES_Encrypt(Key_m, Rnd_C) by use of the pseudo random number Rnd_C in step S54, and stores the encryption key in the key storage part 54 in step S55.

Thereby, the encryption adapters 12A, 12B, and 12C can encrypt or decrypt data by use of the same encryption key Key_data.

In this way, the reset encryption key can be shared among the encryption adapters in a simple work of serially connecting a plurality of encryption adapters without the input of a password or the use of a dedicated application or the like.

Additionally, the example assumes that the encryption adapter 12C generates a pseudo random number, but the encryption adapter 12A or the encryption adapter 12B may of course generate a pseudo random number.

### <4. Second Example of Sharing Encryption Key>

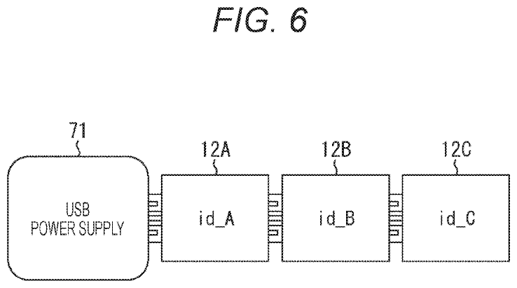

FIG. 6 is a diagram illustrating a second example of sharing an encryption key.

In the example of FIG. 6, three encryption adapters 12A, 12B, and 12C are serially connected. Further, the encryption adapter 12A is connected to the USB power supply 71.

A key distribution master key Key_m is embedded in a region which is difficult to access from the outside (the key storage part 54) in the encryption adapters 12A, 12B, and 12C, respectively, before shipment. Further, the encryption adapters 12A, 12B, and 12C are given unique IDs id_A, id_B, and id_C, respectively.

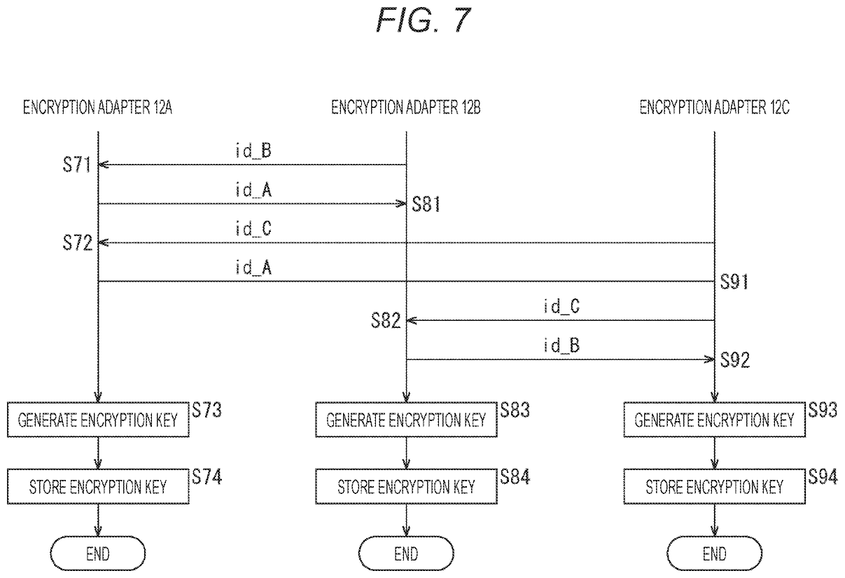

A flow of the processing of sharing a reset encryption key among encryption adapters will be described herein with reference to FIG. 7.

Here, there will be first described an example in which the encryption adapter 12B is connected to the encryption adapter 12A, and then the encryption adapter 12C is connected to the encryption adapter 12B.

At first, when the encryption adapter 12B is connected to the encryption adapter 12A, in step S71, the encryption adapter 12A acquires the unique ID id_B from the encryption adapter 12B. Similarly, in step S81, the encryption adapter 12B acquires the unique ID id_A from the encryption adapter 12A.

Then, when the encryption adapter 12C is connected to the encryption adapter 12B, in step S72, the encryption adapter 12A acquires the unique ID id_C from the encryption adapter 12C via the encryption adapter 12B. Similarly, in step S91, the encryption adapter 12C acquires the unique ID id_A from the encryption adapter 12A via the encryption adapter 12B.

Further, in step S82, the encryption adapter 12B acquires the unique ID id_C from the encryption adapter 12C. Similarly, in step S92, the encryption adapter 12C acquires the unique ID id_B from the encryption adapter 12B.

The key generation part 55 in the encryption adapter 12A couples the acquired unique IDs in the order of connection and calculates a keyed hash value by use of the coupled unique IDs thereby to generate an encryption key Key_data=AES_CBC_MAC(Key_m, id_A∥id_B∥id_C) in step S73, and stores the encryption key in the key storage part 54 in step S74.

The key generation part 55 in the encryption adapter 12B couples the acquired unique IDs in the order of connection and calculates a keyed hash value by use of the coupled unique IDs thereby to generate an encryption key Key_data=AES_CBC_MAC (Key_m, id_A∥id_B∥id_C) in step S83, and stores the encryption key in the key storage part 54 in step S84.

The key generation part 55 in the encryption adapter 12C couples the acquired unique IDs in the order of connection, and calculates a keyed hash value by use of the coupled unique IDs thereby to generate an encryption key Key_data=AES_CBC_MAC (Key_m, id_A∥id_B∥id_C) in step S93, and stores the encryption key in the key storage part 54 in step S94.

Thereby, the encryption adapters 12A, 12B, and 12C can encrypt or decrypt data by use of the same encryption key Key_data.

In this way, the encryption adapters can share the reset encryption key in a simple work of serially connecting a plurality of encryption adapters in a specific order without the input of a password or the use of a dedicated application or the like.

### <5. Third Example of Sharing Encryption Key>

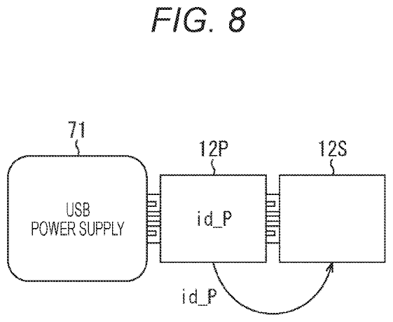

FIG. 8 is a diagram illustrating a third example of sharing an encryption key.

In the example of FIG. 8, two encryption adapters 12P and 12S are mutually connected. The encryption adapter 12P is connected to the USB power supply 71. In the example, the encryption adapter 12P functions as a master and the encryption adapter 12S functions as a slave.

A key distribution master key Key_m is embedded in a region which is difficult to access from the outside (the key storage part 54) in the encryption adapters 12P and 12S before shipment. Further, the master encryption adapter 12P is given a unique ID of id_P.

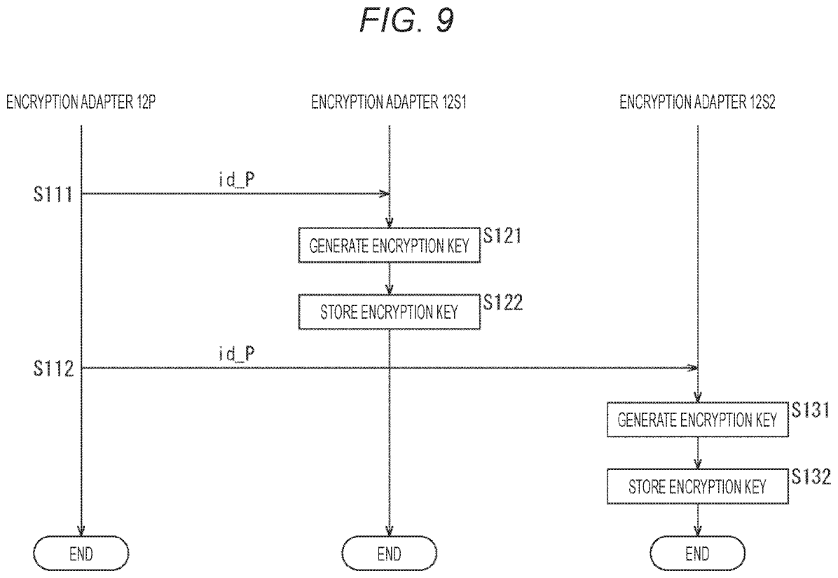

A flow of the processing of sharing a reset encryption key among encryption adapters will be described herein with reference to FIG. 9.

Here, there will be first described an example in which a slave encryption adapter 12S1 is connected to the master encryption adapter 12P, and then the other slave encryption adapter 12S2 is connected to the master encryption adapter 12P.

At first, when the encryption adapter 12S1 is connected to the encryption adapter 12P, the encryption adapter 12P transfers the unique ID id_P to the encryption adapter 12S1 in step S111.

The key generation part 55 in the encryption adapter 12S1 generates an encryption key Key_data=AES_Encrypt (Key_m, id_P) by use of the transferred unique ID in step S121, and stores the encryption key in the key storage part 54 in step S122.

Then, when the encryption adapter 12S2 instead of the encryption adapter 12S1 is connected to the encryption adapter 12P, the encryption adapter 12P transfers the unique ID id_P to the encryption adapter 12S2 in step S112.

The key generation part 55 in the encryption adapter 12S2 generates an encryption key Key_data=AES_Encrypt (Key_m, id_P) by use of the transferred unique ID in step S131, and stores the encryption key in the key storage part 54 in step S132.

Thereby, the encryption adapters 12S1 and 12S2 can encrypt or decrypt data by use of the same encryption key Key_data.

In this way, the encryption adapters can share the reset encryption key in a simple work of connecting a plurality of slave encryption adapters to a master encryption adapter without the input of a password or the use of a dedicated application or the like.

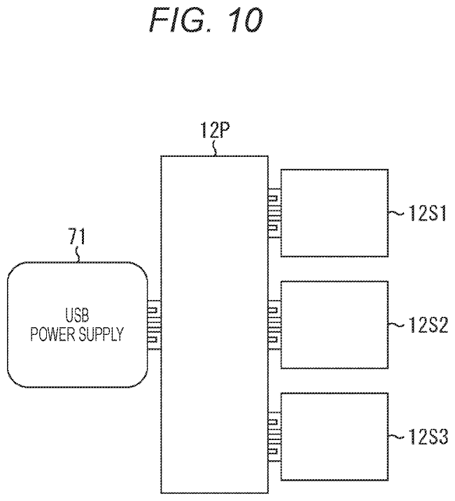

Additionally, as shown in FIG. 10, there may be configured such that the master encryption adapter 12P can be connected to a plurality of (three in the example of FIG. 10) slave encryption adapters 12S1, 12S2, and 1253 at the same time. Thereby, the slave encryption adapters do not need to be attached to or detached from the master encryption adapter one by one.

### <6. Fourth Example of Sharing Encryption Key>

It has been assumed above that encryption adapters are connected so that a reset encryption key is shared, but encryption adapters make communication with a plurality of communication devices thereby to share a reset encryption key.

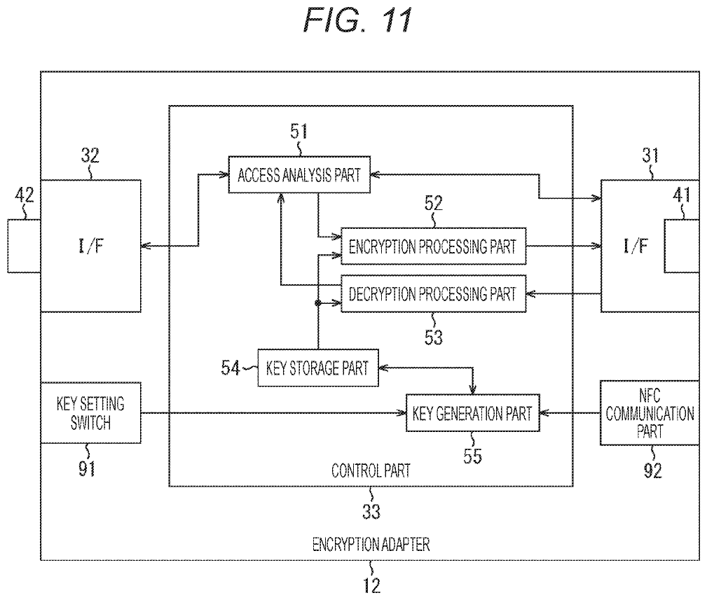

FIG. 11 is a block diagram illustrating an exemplary configuration of the encryption adapter 12 capable of making near field communication (NFC) communication with a communication device configured to make NFC communication.

The encryption adapter 12 of FIG. 11 includes a key setting switch 91 and an NFC communication part 92 in addition to the similar components to the encryption adapter 12 of FIG. 2.

The key setting switch 91 is configured of a user-operable physical switch, for example. ON/OFF of the key setting switch 91 serves as a trigger of generating an encryption key in the key generation part 55.

The NFC communication part 92 makes NFC communication with a communication device configured to make NFC communication.

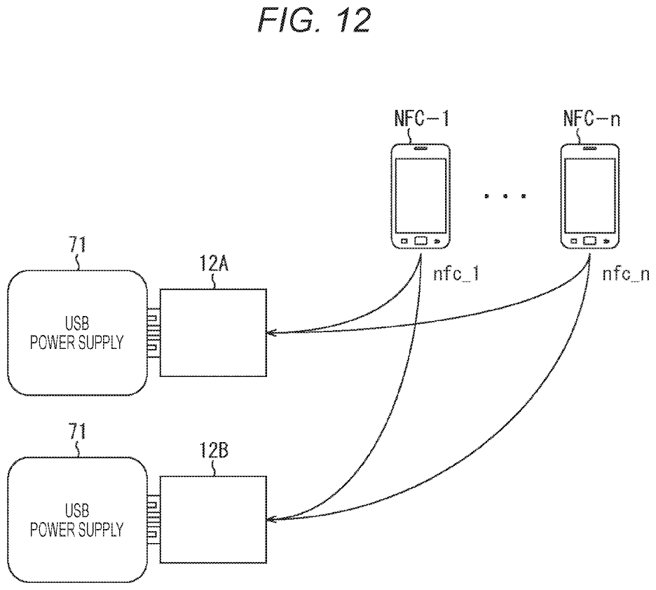

FIG. 12 is a diagram illustrating a fourth example of sharing an encryption key.

In the example of FIG. 12, two encryption adapters 12A and 12B are connected to individual USB power supplies 71, respectively. The encryption adapters 12A and 12B have the configuration illustrated in FIG. 11, and can make NFC communication with n communication devices NFC_1 to NFC_n configured to make NFC communication.

A key distribution master key Key_m is embedded (stored) in a region which is difficult to access from the outside (the key storage part 54) in the encryption adapters 12A and 12B before shipment. Further, the communication devices NFC_1 to NFC_n are given device IDs nfc_1, . . . , nfc_n, respectively.

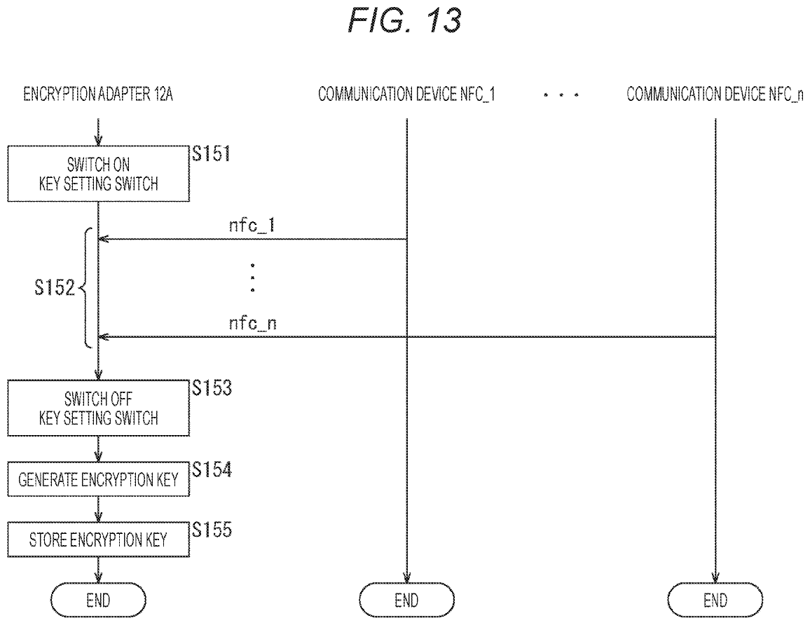

A flow of the processing of sharing a reset encryption key among encryption adapters will be described herein with reference to FIG. 13.

There will be described herein an example in which n communication device NFC_1 to NFC_n are sequentially touched to the encryption adapter 12A.

In step S151, when the key setting switch 91 is switched ON by a user operation, the encryption adapter 12A sets the state of the key generation part 55 to be active.

Thereafter, when the communication device NFC_1 is touched to the encryption adapter 12A, in step S152, the NFC communication part 92 in the encryption adapter 12A makes NFC communication with the communication device NFC_1 thereby to acquire the device ID nfc_1 of the communication device NFC_1.

Further, when the communication device NFC_2 and its subsequent communication devices are sequentially touched to the encryption adapter 12A, the NFC communication part 92 in the encryption adapter 12A acquires the device IDs nfc_2 to nfc_n of the communication devices NFC 2 to NFC_n in the order of touch.

The device IDs acquired by the NFC communication part 92 are sequentially supplied to the key generation part 55.

In step S153, when the key setting switch 91 is switched OFF by a user operation, the key generation part 55 stops acquiring a device ID from the NFC communication part 92.

The key generation part 55 in the encryption adapter 12A couples the device IDs supplied from the NFC communication part 92 in the order of their acquisition and calculates a keyed hash value by use of the coupled device IDs thereby to generate an encryption key Key_data=SHA256(Key_m, nfc_1// . . . //nfc_n) in step S154, and stores the encryption key in the key storage part 54 in step S155.

The example in which n communication devices NFC_1 to NFC_n are sequentially touched to the encryption adapter 12A has been described above, but n communication devices NFC_1 to NFC_n are sequentially touched to the encryption adapter 12B so that the similar processings as in the encryption adapter 12A are performed.

Thereby, the encryption adapters 12A and 12B can encrypt or decrypt data by use of the same encryption key Key_data.

In this way, the encryption adapters can share the reset encryption key in a simple work of touching a plurality of communication devices configured to make NFC communication to a plurality of encryption adapters in a specific order without the input of a password or the use of a dedicated application or the like.

<7. Example in which Data is not Read and Written in Other than Specific Adapter>

In the meantime, in a case where data encrypted by an encryption adapter and written in the removable storage is read/written via an encryption adapter other than the corresponding encryption adapter, the data can be broken or erased.

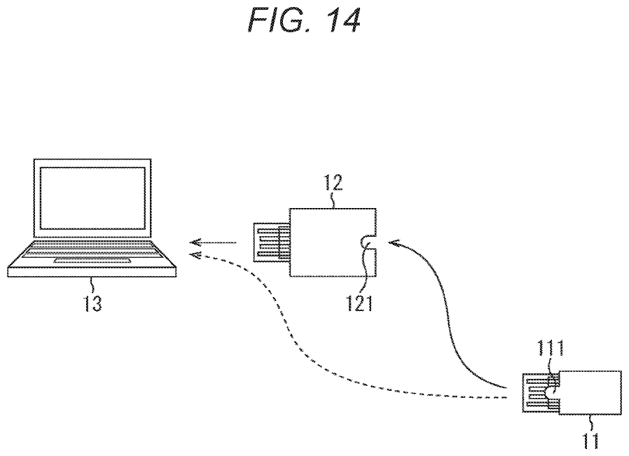

In order to prevent such an accident, for example, as illustrated in FIG. 14, a fitting part (convex part) 111 is provided near the plug of the removable storage 11 and a fitted part (recessed part) 121 fitting with the fitting part 111 is provided near the socket of the encryption adapter 12.

With the structure, the plug of the removable storage 11 is not easily inserted into the socket of other than the corresponding encryption adapter 12, such as the host device 13 or an encryption adapter not having the fitted part 121. Consequently, the data written in the removable storage 11 can be prevented from being erroneously broken or erased.

Additionally, in a case where the removable storage 11 is in the form of card such as SD memory card, a convex part is provided at a predetermined part, and a recessed part fitting with the convex part is provided in the encryption adapter 12 in the form of card reader/writer or the like.

Further, the casing of an encryption adapter having the same encryption key (common key) among a plurality of encryption adapters and the casing of the removable storage in which data encrypted by the encryption key is written may be provided with graphics or pictures making one mark when mutually connected.

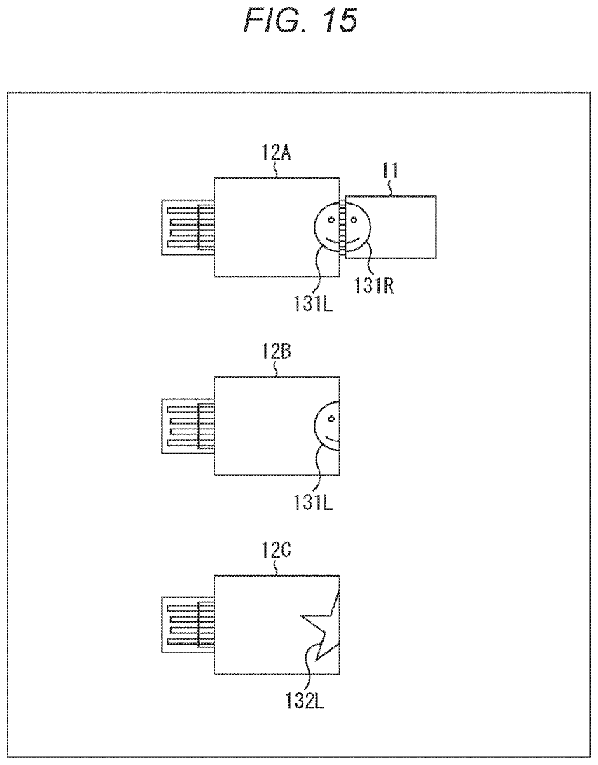

For example, the example of FIG. 15 assumes that the encryption adapters 12A and 12B among the three encryption adapters 12A, 12B, and 12C have the same encryption key and data encrypted by the encryption key is written in the removable storage 11. Further, it is assumed that the encryption adapter 12C has a different encryption key from the encryption key of the encryption adapters 12A and 12B.

In this case, a graphic 131L corresponding to a graphic 131R drawn in the casing near the plug of the removable storage 11 is drawn in the casings near the sockets of the encryption adapters 12A and 12B.

The encryption adapter 12A or 12B is connected to the removable storage 11 so that the graphic 131R and the graphic 131L make one mark.

On the other hand, a graphic 132L drawn in the casing near the socket of the encryption adapter 12C does not correspond to the graphic 131R drawn in the casing near the plug of the removable storage 11.

With the configuration, the user can immediately grasp a combination of an encryption adapter and the removable storage, thereby preventing the removable storage from being connected to an encryption adapter other than the corresponding encryption adapter and the data written in the removable storage from being erroneously broken or erased.

Embodiments of the present technology are not limited to the above embodiments, and can be variously modified without departing from the spirit of the present technology.

Further, the present technology can take the following configurations.

(1) An adapter apparatus including:

an encryption processing part configured to encrypt data written in a storage apparatus;

a decryption processing part configured to decrypt the data read from the storage apparatus; and

a key storage part configured to store the same common key as a key used to encrypt and decrypt the data and stored in another adapter apparatus.

(2) The adapter apparatus according to (1),

in which the key storage part stores the previously-prepared common key.

(3) The adapter apparatus according to (2), further including:

a key generation part configured to generate the common key,

in which the key storage part further stores the common key generated by the key generation part.

(4) The adapter apparatus according to (3),

in which the key generation part generates the common key when the adapter apparatus is connected to the other adapter apparatus.

(5) The adapter apparatus according to (4),

in which the key generation part generates the common key by use of a pseudo random number generated by the adapter apparatus or the other adapter apparatus.

(6) The adapter apparatus according to (4),

in which the key generation part generates the common key by use of respective unique IDs of the adapter apparatus and the other adapter apparatus.

(7) The adapter apparatus according to (6),

in which the key generation part generates the common key by use of the unique IDs coupled in order of connection of the adapter apparatus and the other adapter apparatus.

(8) The adapter apparatus according to (4),

in which the key generation part generates the common key by use of a unique ID of the other adapter apparatus as a master.

(9) The adapter apparatus according to (3), further including:

a communication part configured to make communication with a communication device,

in which the key generation part generates the common key by use of device IDs of a plurality of communication devices acquired when the communication part makes communication with the plurality of communication devices.

(10) The adapter apparatus according to (9),

in which the key generation part generates the common key by use of the device IDs coupled in order of acquisition.

(11) The adapter apparatus according to (9) or (10),

in which the communication part makes near field communication (NFC) communication with the communication device.

(12) The adapter apparatus according to any of (1) to (11), further including:

a socket into which a plug of the storage apparatus is inserted,

in which a fitted part fitting with a fitting part provided near the plug of the storage apparatus is provided near the socket.

(13) A processing method including steps performed by an adapter apparatus of:

generating a common key; and

storing the generated common key,

the adapter apparatus including:

an encryption processing part configured to encrypt data written in a storage apparatus;

a decryption processing part configured to decrypt the data read from the storage apparatus; and

a key storage part configured to store the same common key as a key used to encrypt and decrypt the data and stored in another adapter apparatus.

### REFERENCE SIGNS LIST

11 Removable storage
12 Encryption adapter
13, 14 Host device
31, 32 I/F
33 Control part
41 Socket
42 Plug
51 Access analysis part
52 Encryption processing part
53 Decryption processing part
54 Key storage part
55 Key generation part
91 Key setting switch
92 NFC communication part
111 Fitting part
121 Fitted part

1. An adapter apparatus comprising:
an encryption processing part configured to encrypt data written in a storage apparatus;
a decryption processing part configured to decrypt the data read from the storage apparatus; and
a key storage part configured to store a same common key as a key used to encrypt and decrypt the data and stored in another adapter apparatus.

2. The adapter apparatus according to claim 1,
wherein the key storage part stores the previously-prepared common key.

3. The adapter apparatus according to claim 2, further comprising:
a key generation part configured to generate the common key,
wherein the key storage part further stores the common key generated by the key generation part.

4. The adapter apparatus according to claim 3,
wherein the key generation part generates the common key when the adapter apparatus is connected to the other adapter apparatus.

5. The adapter apparatus according to claim 4,
wherein the key generation part generates the common key by use of a pseudo random number generated by the adapter apparatus or the other adapter apparatus.

6. The adapter apparatus according to claim 4,
wherein the key generation part generates the common key by use of respective unique IDs of the adapter apparatus and the other adapter apparatus.

7. The adapter apparatus according to claim 6,
wherein the key generation part generates the common key by use of the unique IDs coupled in order of connection of the adapter apparatus and the other adapter apparatus.

8. The adapter apparatus according to claim 4,
wherein the key generation part generates the common key by use of a unique ID of the other adapter apparatus as a master.

9. The adapter apparatus according to claim 3, further comprising:
a communication part configured to make communication with a communication device,
wherein the key generation part generates the common key by use of device IDs of a plurality of communication devices acquired when the communication part makes communication with the plurality of communication devices.

10. The adapter apparatus according to claim 9,
wherein the key generation part generates the common key by use of the device IDs coupled in order of acquisition.

11. The adapter apparatus according to claim 9,
wherein the communication part makes near field communication (NFC) communication with the communication device.

12. The adapter apparatus according to claim 1, further comprising:
a socket into which a plug of the storage apparatus is inserted,
wherein a fitted part fitting with a fitting part provided near the plug of the storage apparatus is provided near the socket.

13. A processing method comprising steps performed by an adapter apparatus of:
generating a common key; and
storing the generated common key,
the adapter apparatus comprising:
an encryption processing part configured to encrypt data written in a storage apparatus;
a decryption processing part configured to decrypt the data read from the storage apparatus; and
a key storage part configured to store a same common key as a key used to encrypt and decrypt the data and stored in another adapter apparatus.
